(19) United States
(12) Patent Application Publication
(10) Pub. No.: US 2011/0127025 A1
(43) Pub. Date: Jun. 2, 2011

(54) AIR CONDITIONER FOR A MOTOR VEHICLE

(75) Inventors: Aiko BÕHME, Ingelheim (DE); Heiko BALD, Modautal (DE)

(73) Assignee: GM GLOBAL TECHNOLOGY OPERATIONS, INC., Detroit, MI (US)

(21) Appl. No.: 12/953,308

(22) Filed: Nov. 23, 2010

(30) Foreign Application Priority Data
Nov. 27, 2009 (DE) 102009056044.0

(51) Int. Cl. B60H 1/32

(52) U.S. Cl. 165/202

(57) ABSTRACT

An air conditioner is provided for a motor vehicle, which has a controller and at least thermal conditioning element/thermal conditioner (such as a heater and/or cooler), which is coupled with at least one thermal storage medium arranged inside a passenger cell of the vehicle. The heater and/or cooler can be activated independently of the operating mode of the vehicle transmission, and the controller is designed to regulate the heater or cooler at least taking into account the outside temperature.

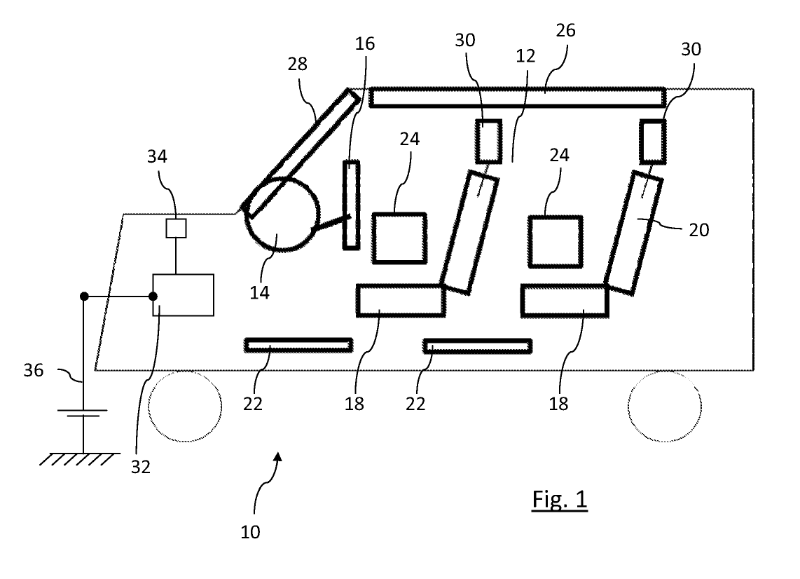

### CROSS-REFERENCE TO RELATED APPLICATION

This application claims priority to German Patent Application No. 102009056044.0, filed Nov. 27, 2009, which is incorporated herein by reference in its entirety.

### TECHNICAL FIELD

The technical field relates to an air conditioner for a motor vehicle, in particular a device for preliminarily conditioning the air in the motor vehicle passenger compartment, which can be activated independently of the operating mode of a vehicle transmission. The technical field relates to a method for controlling the passenger compartment temperature of a motor vehicle passenger cell.

### BACKGROUND

Devices for preliminarily conditioning the air in the passenger compartment of passenger cells of motor vehicles, in particular of passenger cars, are known as such in prior art. They are most often designed as auxiliary heaters, and can be used, for example by way of a remote controller or timer, to heat up the motor vehicle passenger compartment already before starting up the motor vehicle, and if necessary to preheat the vehicle transmission.

However, the disadvantage here arises if the auxiliary heater must be battery operated. In such applications, the vehicle battery must be given sufficiently large dimensions, thereby increasing the space required by the battery and the vehicle weight. In electric or hybrid vehicles, this is especially disadvantageous, since these vehicles have a limited range in the electric mode anyway, since the available electrical energy storage capabilities are only finite, and have a limited range. As a result, the implementation of a battery-powered auxiliary heater would take away from the range in such vehicles.

Further known from DE 102 27 131 A1 is a latent heat storage system incorporated in the upholstery of a seat element of a motor vehicle, which has channels for cooling water. In this case, the upholstery integrates at least one flexible heating cushion, which is filled with a super coolable fluid that can be exothermally crystallized out. The heating cushion here influences the hardness of the upholstery, depending on the aggregate condition.

In view of the foregoing, at least one object is to provide an air conditioner for the motor vehicle passenger compartment that can be operated independently of the operating mode of the vehicle transmission, and without using a vehicle battery. At last another object is to provide a largely automated and automatically operating air conditioner that generates a desired and optimized climate in the passenger compartment before starting up the vehicle, while making as little use of energy resources inside the vehicle. In addition, other objects, desirable features and characteristics will become apparent from the subsequent summary and detailed description, and the appended claims, taken in conjunction with the accompanying drawings and this background.

### SUMMARY

The air conditioner according to an embodiment is provided for a motor vehicle, in particular for a passenger car. It has a controller and at least one heater and/or cooler. The heater and/or cooler is here coupled with at least one thermal storage medium arranged inside a passenger cell of the vehicle. The heater and/or cooler is further provided as an auxiliary heater or auxiliary cooler for the vehicle, and can be activated or operated independently of the operating mode of the vehicle transmission, so that the passengers can already enjoy a desired and comfortable climate in the passenger cell as travel commences.

Among other things, the controller of the air conditioner is designed to control the heater and/or cooler, at least taking into account the outside temperature. This makes it possible to provide a largely self-regulating, in particular self-activating air conditioner for the passenger cell of motor vehicles.

The controller is designed to prepare and generate a prescribed climate inside the vehicle as a function of a measured or sensor-detected outside temperature, in particular even with the vehicle engine turned off. Depending on the season and where the motor vehicle is parked, the controller can perform a comparison between the actual and desired temperatures within the vehicle passenger compartment and the prevailing outside temperature, and either heat or actively cool the passenger cell accordingly. The controller or heater and/or cooler can here be activated starting at a prescribed deviation of the actual temperature from a desired temperature, and taking into account the prevailing outside temperature.

A first embodiment provides that the controller be designed to regulate the heater and/or cooler by further taking exposure to sunlight into consideration. To this end, the controller is at least supplied with signals from an outside temperature and/or passenger compartment temperature sensor. In addition, the controller can be coupled with a light or UV sensor to measure the level of exposure to sunlight, thereby using the latter to regulate the heater and/or cooler.

Another embodiment provides that the heater and/or cooler can be activated exclusively when the vehicle is coupled to an external energy source. In this way, it can be ensured that no onboard energy resources are used for the auxiliary heater or auxiliary air conditioner. This means that the auxiliary heating or auxiliary air conditioning of the motor vehicle passenger cell takes place exclusively via the supply of external energy, so that energy storage units within the vehicle remain largely unused, at least for the auxiliary heater or auxiliary air conditioner. This proves advantageous in particular for electric and hybrid vehicles, in that the operation of an auxiliary heater or auxiliary air conditioner will have no negative impact on the range of the vehicle.

Another embodiment further provides that the controller be designed to deactivate the heater or cooler in response to a separation of the vehicle from an external energy source. If the heater and/or cooler is in a passenger cell heating or cooling phase, and an external electrical energy supply source provided for operating heaters and/or coolers is interrupted, e.g., before travel commences, this results in the immediate deactivation of the heater or cooler so as not to burden the vehicle battery.

Another embodiment provides that the thermal storage medium is integrated in existing passenger compartment components of the passenger cell. The storage medium can here be designed as a latent heat storage system, for example, and execute a phase transition or change in its aggregate state to store thermal energy. The thermal storage medium can consist of common latent heat storage materials, such as sodium acetate-trihydrate fixing salt (sodium thiosulfate), Glauber's salt (sodium sulfate) as well as magnesium nitrate-hexahydrate with added lithium nitrate. The respective thermal storage medium is either situated in direct contact with the heater and/or cooler, or thermally coupled with the latter indirectly by way of a heat carrier. Providing a thermal storage medium in the vehicle passenger compartment makes it possible to store a comparatively high amount of energy directly in the passenger cell already before travel commences, which can be continuously released to the passenger compartment in the form of cold or heat once the vehicle is started up.

Another embodiment provides that the thermal storage medium be divided into a plurality of storage modules, or that a plurality of spatially separated storage modules be provided, which are filled with the thermal storage medium. The individual storage modules can here be integrated into a plurality of varying passenger compartment components of the passenger cell, for example in a vehicle seat, a seat cushion, a backrest, a headrest, an armrest, a lateral paneling, a roof liner, a steering wheel, an instrument panel, the A, B and/or C column panelings and/or a floor covering.

Depending on the selected specific geometric configuration of the individual storage modules and how they are arranged on or in the motor vehicle passenger compartment components, the individual storage modules are each locally coupled with a heating or cooling element, for example an electrically actuatable Peltier element. Additionally or alternatively, the individual storage modules can be thermally coupled with a heating or cooling agent circulation system to bring the heating or cooling agent from a central area, such as a single heater and/or cooler, to a desired temperature level, and then impart the latter to the individual thermal storage modules.

It can further be provided that the individual storage modules are designed to be heated and/or cooled separately from each other. In this way, the thermal storage modules arranged in various positions within the vehicle passenger cell can be used independently from each other to generate local and separate climate zones within the passenger cell. In like manner, the thermal storage module can be “discharged” in a controlled way, so that, depending on what the vehicle passengers want, there can be a comparatively fast discharge associated with a short-term, high heating or cooling output, or a largely prolonged and continuous release of thermal energy to the vehicle passenger cell. In addition to the described air conditioner, a motor vehicle equipped with an air conditioner according to the invention.

Embodiments further relate to a method for regulating the passenger compartment temperature of a motor vehicle passenger cell. The method runs through the following steps. A check is first performed to determine whether the vehicle is connected to an external energy source, such as an electrical power supply. In this case, the outside and passenger compartment temperature are initially determined by means of sensors provided for this purpose, and compared to each other. Given a deviation between the outside and passenger compartment temperature that exceeds a prescribed limit, which can be selected as a function of the respective temperature level, a heater and/or cooler is activated via a controller of the air conditioner.

The heater and/or cooler is operated by the assigned controller until such time as the deviation between the desired and actual temperature drops below a prescribed threshold. The desired temperature can here either be firmly stipulated by the user, or selected automatically by the controller as a function of the prevailing outside temperature, season and exposure to sunlight. The heater and/or cooler is activated in particular to heat and/or cool at least one thermal storage medium arranged inside the passenger vehicle cell, in particular a latent heat storage system. Even though a latent heat storage system has a comparatively high storage capacity for thermal energy, the invention is in no way strictly limited to latent heat storage materials as the storage media. A great variety of thermal storage media can be used, such as water or comparable fluids, as well as solids with a comparatively high heating capacity. For example, paraffin, in particular hard paraffin, can basically be considered for use as a thermal storage medium for the present invention.

Among other things, the method is characterized in that the heater and/or cooler is deactivated when the vehicle is decoupled from the external energy source, in particular from an electrical energy source. Correspondingly, another embodiment can also provide that the heater and/or cooler be independently activated by coupling the vehicle to the external energy source. The vehicle passenger cell or vehicle passenger compartment is then brought to a prescribed temperature level, largely circumventing onboard energy storage units, wherein the heating or cooling power is regulated with consideration of the respective prevailing outside temperature.

Another embodiment further provides that the thermal storage medium releases the stored thermal energy in a controlled manner by means of a controller with the vehicle in operation. In this way, the thermal energy stored inside the vehicle passenger cell can be used to support a vehicle heater and/or to support a vehicle air conditioner.

Other objectives, advantages and advantageous possible applications of the invention will be explained in the following description of an exemplary embodiment, making reference to the drawing. All features described in the text and graphically depicted on the FIGURE here comprise the subject matter of the present invention, whether taken separately or in any logical combination with each other.

### BRIEF DESCRIPTION OF THE DRAWINGS

The present invention will hereinafter be described in conjunction with the following drawing FIGURE, which shows a simplified, diagrammatic view of a motor vehicle with highlighted passenger compartment components, such as a vehicle seat pad, a seat backrest, a headrest, a door inner lining (shown only diagrammatically), a roof liner, an A-column paneling, and a floor covering.

### DETAILED DESCRIPTION

The following detailed description is merely exemplary in nature and is not intended to limit application and uses. Furthermore, there is no intention to be bound by any theory presented in the preceding background or summary or the following detailed description.

The motor vehicle 10 or its air conditioner according to an embodiment has a controller 32, which activates one or more thermal conditioning elements, such as heating and/or cooling elements (not shown in any greater detail in the FIGURE) to heat or cool the vehicle passenger cell when the motor vehicle 10 is coupled with an external energy source 36, such as an electrical energy source. The heating and/or cooling elements are here preferably arranged in combination with at least one thermal storage medium on or in the passenger compartment components 14, 16, 18, 20, 22, 24, 26, 28, 30 mentioned above to regulate the temperature therein.

As an alternative, at least several of the mentioned components 14, 16, 18, 20, 22, 24, 26, 28, 30 can be provided with a thermal storage medium, which is preferably to be integrated into the mentioned components. The thermal storage medium can here be designed as a latent heat storage medium, which permanently stores supplied thermal energy while changing its aggregate state, and can reversibly release it again as needed.

It is here conceivable in particular to equip at least some of the vehicle passenger compartment components with thermal storage modules, which are separately and/or individually thermally coupled with a heating or cooling element. It is further conceivable to couple at least several, or even all, of the thermal storage modules with a heating or cooling circulation, which supplies thermal energy made available by a central heater and/or cooler via a circulating heating and/or cooling agent to the respective thermal storage modules.

The controller 32 for operating the heater and/or cooler is further coupled with at least one sensor device 34, which furnishes information about the outside temperature and/or incident sunlight. Depending on a desired temperature, for example prescribed by the user, the controller 32 can hence independently initiate a heating or cooling of the thermal storage modules integrated into the passenger compartment components 18, 20, 22, 24, 26, 28, 30.

The heater and/or cooler preferably operates only when the motor vehicle 10 is connected to an external energy source 36, such as an electrical power supply. In this way, the air in the motor vehicle passenger cell 12 can be preliminarily conditioned as desired, without burdening onboard energy storage units. In particular, it is provided that the heater and/or cooler is immediately deactivated once the motor vehicle 10 is decoupled from the external energy supply 36, so that, if possible, all energy reserves of the motor vehicle 10 can be made available to the corresponding transmission unit, in particular in the case of an electric or hybrid transmission.

The storage of thermal energy within the vehicle passenger cell 12 also proves advantageous from the standpoint that the thermal energy is stored directly in those regions of a vehicle where they also end up being needed. This makes it possible to reduce any transport-related thermal energy losses. Implementing thermal storage media inside the motor vehicle seat 18, 20, 30, for example, also makes it possible to provide the user with an immediate heat or cold emitting effect. In particular, it is here conceivable that several individual storage modules be arranged side-by-side and/or one atop the other, for example in the backrest 20 or seat 18. While the air is preconditioned according to the invention with the vehicle standing idle, the storage module can be heated or cooled to a prescribed or individually user-desired temperature level, depending on the prevailing outside temperature. Further, the user can individually time the release or discharge characteristics of the storage module after the vehicle has been started up, since the controller provided for preconditioning the air is coupled with a vehicle heater or vehicle air conditioner.

Depending on what is required by the user, the heat stored in the thermal storage module can be released to the vehicle passenger cell 12 or directly to body regions of the vehicle passenger either over a comparatively short period of time by way of a high heating or cooling output, or continuously by way of a low heating or cooling output.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An air conditioner for a motor vehicle having a passenger cell and a transmission, comprising:
a thermal storage medium within the passenger cell;
a thermal conditioning element coupled with the thermal storage medium and adapted for independent activation of an operating mode of the transmission; and
a controller configured to regulate the thermal conditioning element based at least in part upon consideration of an outside temperature.

2. The air conditioner according to claim 1, wherein the thermal conditioning element is a heater.

3. The air conditioner according to claim 1, wherein the thermal conditioning element is a cooler.

4. The air conditioner according to claim 1, wherein the thermal conditioning element is a heater and a cooler.

5. The air conditioner according to claim 1, wherein the controller is further configured to regulate the thermal conditioning element based at least in part on an exposure to sunlight.

6. The air conditioner according to claim 1, further comprising:
a temperature sensor adapted to sense the outside temperature,
wherein the controller is further configured to receive the outside temperature from the temperature sensor.

7. The air conditioner according to claim 1, wherein the thermal conditioning element is adapted for activation exclusively when the motor vehicle is coupled to an external energy source.

8. The air conditioner according to claim 1, wherein the controller is configured to deactivate the thermal conditioning element in response to a separation of the motor vehicle from an external energy source.

9. The air conditioner according to claim 1, wherein the thermal storage medium is integrated into a passenger compartment component of the passenger cell.

10. The air conditioner according to claim 1, further comprising a plurality of storage modules arranged in a seat component.

11. The air conditioner according to claim 10, wherein the seat component is a backrest.

12. The air conditioner according to claim 1, further comprising a plurality of storage modules arranged in a lateral paneling.

13. The air conditioner according to claim 1, further comprising a plurality of storage modules arranged in a roof liner.

14. The air conditioner according to claim 1, further comprising a plurality of storage modules arranged in a steering wheel.

15. The air conditioner according to claim 1, further comprising a plurality of storage modules arranged in an instrument panel.

16. The air conditioner according to claim 1, further comprising a plurality of storage modules arranged in a column paneling

17. The air conditioner according to claim 16, wherein the column paneling is an A-column paneling.

18. The air conditioner according to claim 1, further comprising a plurality of storage modules arranged in a floor covering.

19. The air conditioner according to claim 10, wherein a first storage module of the plurality of storage modules is adapted to thermally condition separately from a second storage module of the plurality of storage modules.

20. A motor vehicle, comprising:
a passenger cell;
a transmission;
a thermal storage medium within the passenger cell;
a thermal conditioning element coupled with the thermal storage medium and adapted for independent activation of an operating mode of the transmission; and
a controller configured to: regulate the thermal conditioning element based at least in part upon consideration of an outside temperature.

21. A method for regulating a passenger compartment temperature of a passenger cell of a motor vehicle, comprising:
measuring an outside temperature with an outside temperature sensor;
measuring the passenger compartment temperature with a passenger compartment sensor;
determining if the motor vehicle is connected to an external energy source;
comparing the outside temperature and the passenger compartment temperature with a controller; and
activating a thermal conditioner with the controller based at least upon the comparing the outside temperature and the passenger compartment temperature in order to thermally condition a thermal storage medium situated inside the passenger cell.

22. The method according to claim 21, further comprising deactivating the thermal conditioner with the controller if the motor vehicle is decoupled from the external energy source.

23. The method according to claim 21, wherein further comprising activating the thermal conditioner if the motor vehicle is coupled to the external energy source

24. The method according to claim 21, further comprising releasing stored thermal energy from the thermal storage medium in a controlled by the controller.

25. The method according to claim 21, wherein the thermal conditioner is a heater.

26. The method according to claim 21, wherein the thermal conditioner is a cooler.

27. The method according to claim 21, wherein the thermal conditioner is a heater and a cooler.
